(19) United States
(12) Patent Application Publication
(10) Pub. No.: US 2013/0168096 A1
(43) Pub. Date: Jul. 4, 2013

(54) Additive to Fluid for The Treatment of Subterranean Formation and A Method for Treating Subterranean Formation

(71) Applicant: Schlumberger Technology Corporation, Sugar Land, TX (US)

(72) Inventors: Sergey Dmitrievich Parkhonyuk, Tyumen (RU); Philippe Enkababian, Houston, TX (US); Bernhard Lungwitz, Rio de Janeiro (BR)

(73) Assignee: SCHLUMBERGER TECHNOLOGY CORPORATION, Sugar Land, TX (US)

(21) Appl. No.: 13/717,411

(22) Filed: Dec. 17, 2012

(30) Foreign Application Priority Data
Dec. 30, 2011 (RU) 2011154343

(51) Int. Cl. C09K 8/62; E21B 43/16

(52) U.S. Cl. CPC C09K 8/62; E21B 43/16
USPC 166/305.1; 507/203; 507/241; 507/236

(57) ABSTRACT

The composition includes a pH adjusting agent and a precipitation-control agent. The pH adjusting agent provides the hydrolysis of degradable fibers at a temperature of no more than 50° C. and comprises substances that may provide and maintain a high pH environment. The precipitation-control agent allows maximally delaying or completely suppressing the formation and deposition of precipitate during the hydrolysis of the degradable components in the treatment fluid A method of treating an subterranean formations penetrated by a wellbore with the additives described herein comprises providing a treatment fluid comprising a base mixture and a degradable substance, with additionally added degradable materials, and injecting the prepared treatment fluid into the subterranean formation.

### FIELD OF THE PRESENT APPLICATION

The present application relates to the art of treating subterranean formations and, more particularly, to additives to a fluid treatment composition comprising base mixture and a degradable material, which are capable of improving the properties of the composition, and to methods for treating a subterranean formation with said composition comprising said additives, in particular, to a method of delivering a fluid treatment composition capable of transporting proppants with degradable material into a formation for low temperature application.

### BACKGROUND

Hydraulic fracturing of subterranean formations has long been established as an effective means to stimulate the production of hydrocarbon fluids from a wellbore. In hydraulic fracturing, a well-stimulation fluid (generally referred to as a fracturing fluid) is injected into and through a wellbore and against the surface of a subterranean formation penetrated by the wellbore at a pressure at least sufficient to create a fracture in the formation. Usually a “pad fluid” is injected first to create the fracture and then a fracturing fluid, often bearing granular propping agents, is injected at a pressure and rate sufficient to extend the fracture from the wellbore deeper into the formation. If a proppant is employed, the goal is generally to create a proppant filled zone from the tip of the fracture back to the wellbore. In any event, the hydraulically induced fracture is more permeable than the formation and it acts as a pathway or conduit for the hydrocarbon fluids in the formation to flow to the wellbore and then to the surface where they are collected.

The fluids used as fracturing fluids have also been varied, but many if not most are aqueous based fluids that have been “viscosified” or thickened by the addition of a natural or synthetic polymer (crosslinked or uncrosslinked) or a viscoelastic surfactant (VES). The carrier fluid is usually water or a brine (e.g., dilute aqueous solutions of sodium chloride and/or potassium chloride).

The viscosifying polymer may be a solvatable (or hydratable)polysaccharide, such as a galactomannan gum, a glycomannan gum, or a cellulose derivative. Examples of such polymers include guar, hydroxypropyl guar, carboxymethyl guar, carboxymethylhydroxyethyl guar, hydroxyethyl cellulose, carboxymethylhydroxyethyl cellulose, hydroxypropyl cellulose, xanthan, polyacrylamides and other synthetic polymers.

In many instances, if not most, the viscosifying polymer is crosslinked with a suitable crosslinking agent. The crosslinked polymer has an even higher viscosity and is even more effective at carrying proppant into the fractured formation. The borate ion has been used extensively as a crosslinking agent, typically in high pH fluids, for guar, guar derivatives and other galactomannans. Other crosslinking agents include, for example, titanium, chromium, iron, aluminum, and zirconium.

Viscoelastic surfactant fluids are normally made by mixing into the carrier fluid appropriate amounts of suitable surfactants such as anionic, cationic, nonionic and zwitterionic surfactants. The viscosity of viscoelastic surfactant fluids is attributed to the three dimensional structure formed by the components in the fluids. When the concentration of viscoelastic surfactants exceeds a critical concentration, surfactant molecules aggregate into micelles, which can become highly entangled to form a network exhibiting elastic behavior.

Viscoelastic surfactant solutions are usually formed by the addition of certain reagents to concentrated solutions of surfactants, frequently consisting of long-chain quaternary ammonium salts such as cetyltrimethylammonium bromide (CTAB). Common reagents that generate viscoelasticity in the surfactant solutions are salts such as ammonium chloride, potassium chloride, sodium salicylate and sodium isocyanate and non-ionic organic molecules such as chloroform. The electrolyte content of surfactant solutions is also an control on their viscoelastic behavior.

During hydraulic fracturing treatments, control of fracture height growth can be an issue. In situations where the water table is close to the fracturing zone, or where the fracture zones have low stress barriers, so that fracture height growth can result in screen outs, control of the fracture height may be a factor. A common technique for the control of fracture height control is to use fluids with lower viscosity, such as VES surfactants or linear gels. Lower viscosity fluids however, do not transport the large sized proppants effectively in the fracture.

One of the known methods of addressing the issue is the incorporation of degradable fibers into the surfactant fluids. Degradable fibers are used in various technological processes including carrying proppants, diverting the fluid flow in hydraulic fracturing and acid treatment of carbonates, and, recently, in drilling mud loss. The use of degradable fibers in hydraulic fracturing of a formation (proppant+hydraulic fracturing fluid+degradable fibers) provides, at the beginning, carrying the proppant and obtaining a compacted formation, which prevents the fracture from closing. Then the fibers should be dissolved to increase the proppant pack conductivity. A specific example of a fiber is polylactic acid (PLA), which may be appropriate due to its suitable properties in terms of mechanical properties and degradation, as well as due to its availability and the highest efficiency compared with other degradable materials. Such applications have been disclosed in U.S. Pat. No. 7,565,929, U.S. Pat. No. 7,380,600, U.S. Pat. No. 7,275,596, EP 1,556,458, which are incorporated by reference herein in their entireties.

However, the degradation of fibers and fiber-bearing VES fracturing fluid is known to be problematic. Polylactic acid (PLA) fibers have been shown to degrade into soluble materials under temperature and with time. At temperatures below 82° C., PLA fibers degrade too slowly to be useful for those oilfield applications in the low-temperature wells with temperatures below 82° C., in particular, with temperatures ranging from 10° C. to 50° C. Therefore, the use of biodegradable fibers previously was limited to temperatures above 82° C. based on the rate of their degradation.

Thus, there is a need to develop an improved formulation of an additive to a liquid treatment composition, providing a viscoelastic liquid surfactant composition that can effectively transport large sized proppants while be sufficiently decomposed at low temperature conditions (below 82° C., for example, at 40° C. or 60° C.), leaving small, if any, residual solid components in the fracture.

### SUMMARY

In order to solve the above problems, the present inventors developed an additive to the formation-treatment fluid, containing, at least the following components: a pH adjusting agent (hereinafter referred to as “pH control agent”) to adjust the pH value of the formation-treatment fluid and to accelerate thereby the degradation of degradable fibers; and a precipitation-control agent.

The pH adjusting agent should ensure the pH value equal to or greater than about 9. The pH control agent can, for example, comprise at least one material selected from the group consisting of hydroxides, oxides, carbonates and bicarbonates of alkali and alkaline earth metals.

Another component of the additive may be a precipitation-control agent, which purpose is to prevent or slow down, as much as possible, the formation of insoluble compounds in the working fluid during hydraulic fracturing and other processing of the subterranean formation. According to the present application, as those agents, ethylene diamine tetraacetic acid (EDTA) and/or salts thereof as well as amino trimethylene phosphonic acid (ATMP) and/or salts thereof can be used.

According to another embodiment of the present application, a method of treating a subterranean formation penetrated by a wellbore, using the above additives is provided. Such method includes: providing a treatment fluid comprising a viscosifying polymer or a viscoelastic surfactant having at least one degradable linkage, a hydrolysable material and the additive to the formation-treatment fluid; and injecting the treatment fluid prepared thereby into the subterranean formation.

### BRIEF DESCRIPTION OF THE DRAWINGS

FIG. 1 is a graph plotting the degradation of PLA fibers at 50° C. for 36 hours.

FIG. 2 is a graph of the residual proppant pack conductivity with Ca(OH)₂ at 50° C.

FIG. 3 is a graph of the residual proppant pack conductivity with Ca(OH)₂ at 75° C.

FIG. 4 is a graph of the residual proppant pack conductivity with Ca(OH)₂ and Na₄EDTA at 50° C.

FIG. 5 is a graph of the residual proppant pack conductivity with Ca(OH)₂, NaOH [symbol] AMTP at 50° C.

### DETAILED DESCRIPTION

First of all, it should be noted that the embodiments of the application described in more detail below and examples are presented solely for the purpose of illustrating the feasibility of the general ideas of the present application and should not be construed as limitation of the application to these embodiments. When using the application in practice, the development of any actual embodiment involving a choice of specific conditions and parameters will require numerous decisions depending on the developer's specific goals, such as compliance with the system-related and business-related constraints, which will vary from one decision-related embodiment to another. Such a choice can be made over a wide range of conditions, and said developments can be complex and labor intensive. However, they will be routine for the person of ordinary skill in the art in view of the present disclosure, and the resultant specific embodiments of the present application will correspond to the essence of the present application and fall into its scope determined only by the claims submitted with this application.

In the study of this description, it should be understood that, although the compositions of the present application are described herein as comprising certain substances (materials), they could optionally comprise two or more chemically different materials of the same purpose. In addition, the composition can also comprise some components other than the ones already cited.

Further, in the description of the application, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that inventors appreciate and understand that any and all data points within the range are to be considered to have been specified, and that inventors have disclosed and enabled the entire range and all points within the range.

Unless otherwise specifically stated, all percentages herein are percentages by weight.

According to one embodiment, an additive to the formation-treatment fluid, comprising at least the following components: a pH adjusting agent to adjust a pH value and to accelerate thereby the degradation of degradable fibers; and a precipitation-control agent.

The formation-treatment fluid may be a fluid, comprising viscosifying polymer or viscoelastic surfactant having at least one degradable linkage and degradable material.

The viscosifying polymer comprises a natural or synthetic polymer. In one embodiment, the natural or synthetic polymer includes a hydratable polysaccharide selected from a galactomannan gum, glucomannan gum and cellulose derivatives.

In one embodiment, the viscosifying polymer may be a cellulose derivative selected from guar, hydroxypropyl guar, carboxymethyl guar, carboxymethylhydroxyethyl guar, hydroxyethyl cellulose, carboxymethylhydroxyethyl cellulose, hydroxypropyl cellulose, xanthan.

As an alternative, the formation-treatment fluid can comprise viscoelastic surfactant having at least one degradable linkage.

When the formation-treatment fluid is viscosified by the addition of viscoelastic surfactant systems, the viscosity increase is believed to be due to the formation of micelles, for example worm-like micelles, which entangle to give structure to the fluid that leads to the increase of the viscosity. In addition to the viscosity itself, an aspect of a fluid's properties is the degree of viscosity-recovery or re-healing when the fluid is subjected to high shear and the shear is then reduced. For VES fluids, shear may disrupt the micelle structure, after which the structure reforms. Controlling the degree of reassembling (re-healing) is necessary to maximize performance of the surfactant system for different applications. For example, in hydraulic fracturing, the fluid tends to regain viscosity as quickly as possible after exiting the high-shear region in the tubulars and entering the low-shear environment in the hydraulic fracture. On the other hand, it is beneficial in coiled tubing cleanouts to impart a slight delay in regaining full viscosity in order to “jet” the solids more efficiently from the bottom of the wellbore into the annulus. Once in the annulus the regained viscosity ensures that the solids are effectively transported to the surface. Controlling the viscosity-recovery and the time required for such recovery may be therefore desirable.

In the use according to the present various viscoelastic surfactants (VES) can be employed. Thus, cationic VES, zwitterionic VES and amphoteric VES are suitable. Surfactants with a degradable linkage in the molecule are also suitable. Surfactants with a degradable linkage in the molecule can be hydrolysed to separate the hydrophilic head and the hydrophobic tail. While not wishing to be bound by theory, it is believed that such separation will degrade the micelles formed by the VES surfactant.

In one embodiment, the viscoelastic surfactant has a hydrolysable amide linkage in the terminal group, according to the scheme.

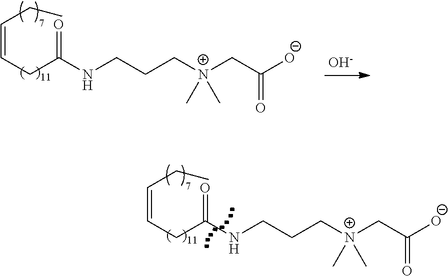

Specific cationic viscoelastic surfactants include the amine salts and quaternary amine salts disclosed in U.S. Pat. Nos. 5,979,557 and 6,435,277 which have a common Assignee as the present application and which are hereby incorporated by reference herein in their entirety.

Examples of suitable cationic viscoelastic surfactants include cationic surfactants having the structure:

R₁N⁺(R₂)(R₃)(R₄)X⁻

in which R₁ has from about 14 to about 26 carbon atoms and may be branched or straight chained, aromatic, saturated or unsaturated, and may contain a carbonyl, an amide, a retroamide, an imide, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ groups more hydrophilic; the R₂, R₃ and R₄ groups may be incorporated into a heterocyclic 5- or 6-member ring structure which includes the nitrogen atom; the R₂, R₃ and R₄ groups may be the same or different; and X⁻ is an anion. Mixtures of such compounds are also suitable. As a further example, R₁ is from about 18 to about 22 carbon atoms and may contain a carbonyl, an amide, or an amine, and R₂, R₃ and R₄ are the same as one another and contain from 1 to about 3 carbon atoms. Cationic surfactants having the structure R₂N⁺(R₂)(R₃)(R₄)X⁻ may optionally contain amines having the structure R₁N(R₂)(R₃). It is well known that commercially available cationic quaternary amine surfactants often contain the corresponding amines (in which R₁, R₂, and R₃ in the cationic surfactant and in the amine have the same structure). As received commercially available VES surfactant concentrate formulations, for example cationic VES surfactant formulations, may also optionally contain one or more members of the group consisting of solvents, mutual solvents, organic acids, organic acid salts, inorganic salts, and oligomers, polymers, co-polymers, and mixtures of these members. They may also contain performance enhancers, such as viscosity enhancers, for example polysulfonates, for example polysulfonic acids, as described in copending U.S. Patent Application Publication No. 2003-0134751 which has a common Assignee as the present application and which is hereby incorporated by reference herein in its entirety.

Another suitable cationic VES is erucyl bis(2-hydroxyethyl)methyl ammonium chloride, (“EMHAC”), also known as (Z)-13 docosenyl-N—N-bis(2-hydroxyethyl)methyl ammonium chloride. It is commonly obtained from manufacturers as a mixture containing about 60 weight percent surfactant in a mixture of iso-propanol, ethylene glycol and water. In this patent, when we refer to “EMHAC” we mean such a solution. Other suitable amine salts and quaternary amine salts include (either alone or in combination), erucyl trimethylammonium chloride; N-methyl-N,N-bis(2-hydroxyethyl) rapeseed ammonium chloride; oleyl methyl bis(hydroxyethyl)ammonium chloride; erucylamidopropyltrimethylamine chloride, octadecyl methyl bis(hydroxyethyl)ammonium bromide; octadecyl tris(hydroxyethyl)ammonium bromide; octadecyl dimethyl hydroxyethyl ammonium bromide; cetyl dimethyl hydroxyethyl ammonium bromide; cetyl methyl bis(hydroxyethyl)ammonium salicylate; cetyl methyl bis(hydroxyethyl)ammonium 3,4,-dichlorobenzoate; cetyl tris(hydroxyethyl)ammonium iodide; cosyl dimethyl hydroxyethyl ammonium bromide; cosyl methyl bis(hydroxyethyl)ammonium chloride; cosyl tris(hydroxyethyl) ammonium bromide; dicosyl dimethyl hydroxyethyl ammonium bromide; dicosyl methyl bis(hydroxyethyl)ammonium chloride; dicosyl tris(hydroxyethyl)ammonium bromide; hexadecyl ethyl bis(hydroxyethyl)ammonium chloride; hexadecyl isopropyl bis(hydroxyethyl)ammonium iodide; and cetylamino, N-octadecyl pyridinium chloride.

Zwitterionic viscoelastic surfactants are also suitable. Zwitterionic viscoelastic surfactants include those described in U.S. Pat. No. 6,703,352 which has a common Assignee as the present application and which is hereby incorporated by reference herein in its entirety. Specific zwitterionic surfactants have the structure:

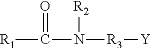

in which R₁ is a hydrocarbyl group that may be branched or straight chained, aromatic, aliphatic or olefinic and contains from about 14 to about 26 carbon atoms and may include an amine; R₂ is hydrogen or an alkyl group having from 1 to about carbon atoms; R₃ is a hydrocarbyl group having from 1 to about 5 carbon atoms; and Y is an electron withdrawing group. More particularly, the zwitterionic surfactant may have the betaine structure:

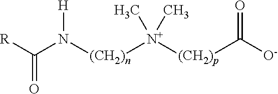

in which R is a hydrocarbyl group that may be branched or straight chained, aromatic, aliphatic or olefinic and has from about 14 to about 26 carbon atoms and may contain an amine; n=about 2 to about 4; and p=1 to about 5. Mixtures of these compounds may also be used.

Two examples of suitable betaines are, respectively, BET-O-30 and BET-E-40. The VES surfactant in BET-O-30 is oleylamidopropyl betaine. It is designated BET-O-30 here, because as obtained from the supplier (Rhodia, Inc. Cranbury, N.J., U.S.A.) it is called Mirataine BET-O-30; it contains an oleyl acid amide group (including a C₁₇H₃₃ alkene tail group) and is supplied as about 30% active surfactant; the remainder is substantially water, sodium chloride, glycerol and propane-1,2-diol. An analogous suitable material, BET-E-40, was used in the experiments described below; one chemical name is erucylamidopropyl betaine. BET-E-40 is also available from Rhodia; it contains a erucic acid amide group (including a C₂₁H₄₁ alkene tail group) and is supplied as about 40% active ingredient, with the remainder substantially water, sodium chloride, and iso-propanol. BET surfactants, and others that are suitable, are described in U.S. Pat. No. 6,703,352, which is incorporated by reference herein in its entirety.

Certain co-surfactants may be useful in extending the brine tolerance, to increase the gel strength, to reduce the shear rehealing time, and/or to reduce the shear sensitivity of zwitterionic VES fluid systems, such as betaine VES fluids. An example given in U.S. Pat. No. 6,703,352 is sodium dodecylbenzene sulfonate (SDBS). Another example is polynaphthalene sulfonate. Zwitterionic VES surfactants may be used with or without this type of co-surfactant, for example those having a SDBS-like structure having a saturated or unsaturated, branched or straight-chained C₆ to C₁₆ chain; further examples of this type of co-surfactant are those having a saturated or unsaturated, branched or straight-chained C₈ to C₁₆ chain. Other suitable examples of this type of co-surfactant, especially for BET-O-30, are certain chelating agents such as trisodium hydroxyethylethylenediamine triacetate. Many suitable additives are known for improving the performance of gelled VES surfactant systems; any may be used; they should be tested for compatibility with the compositions and methods of the present embodiments before use; simple laboratory experiments for such testing are well known.

Zwitterionic surfactant viscoelastic systems may contain one or more members of the group consisting of organic acids, organic acid salts, inorganic salts, and oligomers, polymers, co-polymers, and mixtures of these members. This member is may be present in a minor amount and need not be present at all. The organic acid may be a sulfonic acid or a carboxylic acid and the anionic counter-ion of the organic acid salts are typically sulfonates or carboxylates. Representative of such organic molecules include various aromatic sulfonates and carboxylates such as p-toluene sulfonate, naphthalene sulfonate, chlorobenzoic acid, salicylic acid, phthalic acid and the like, where such counter-ions are water-soluble. Specific examples include salicylate, phthalate, p-toluene sulfonate, hydroxynaphthalene carboxylates, e.g. 5-hydroxy-1-naphthoic acid, 6-hydroxy-1-naphthoic acid, 7-hydroxy-1-naphthoic acid, 1-hydroxy-2-naphthoic acid, 3-hydroxy-2-naphthoic acid, 5-hydroxy-2-naphthoic acid, 7-hydroxy-2-naphthoic acid, 1,3-dihydroxy-3-naphthoic acid and 3,4-dichlorobenzoate. The organic acid or salt thereof typically aids the development of increased viscosity that is characteristic of such fluids. The organic acid or salt thereof may be present in the zwitterionic viscoelastic fluid (after the viscoelastic surfactant has concentrated sufficiently to viscosify the fluid) at a weight concentration of from about 0.1% to about 10%, from about 0.1% to about 7%, and from about 0.1% to about 6%.

Inorganic salts that are particularly suitable for use in the zwitterionic viscoelastic fluid include water-soluble potassium, sodium, and ammonium salts, such as potassium chloride and ammonium chloride. Additionally, calcium chloride, calcium bromide and zinc halide salts may also be used. The inorganic salts may aid in the development of increased viscosity which is characteristic of these fluids. Further, the inorganic salt may assist in maintaining the stability of a geologic formation to which the fluid is exposed. Formation stability and in particular clay stability (by inhibiting hydration of the clay) is achieved at a concentration level of a few percent by weight. The inorganic salt may be present in the zwitterionic viscoelastic fluid (after the viscoelastic surfactant has concentrated sufficiently to viscosify the fluid) at a weight concentration of from about 0.1% to about 30%, from about 0.1% to about 10%, and from about 0.1% to about 8%. Organic salts, e.g. trimethylammonium hydrochloride and tetramethylammonium chloride, may also be used in addition to, or as a replacement for, the inorganic salts. Optionally, these systems may be formed in dense brines, including brines containing polyvalent cations.

As an alternative to the organic salts and inorganic salts, or as a partial substitute therefore, one can use a medium to long chain alcohol such as, for example, a long chain alcohol having five to ten carbon atoms, or an alcohol ethoxylate, such as, for example, an alkanol ethoxylate having 12 to 16 carbon alcohol and having 1 to 6, or 1 to 4, oxyethylene units.

Amphoteric viscoelastic surfactants are also suitable. Examples of specific amphoteric viscoelastic surfactants include those described in U.S. Pat. No. 6,703,352, for example amine oxides. One useful amine oxide surfactant has the formula:

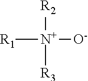

wherein R₁, R₂, and R₃ are independently selected from alkyl, alkenyl, arylalkyl, or hydroxyalkyl groups wherein each of said alkyl groups contain from about 8 to about 24 carbon atoms and may be branched or straight chained and saturated or unsaturated.

Mixtures of zwitterionic surfactants and amphoteric surfactants are also suitable. An example, called BET-E-40/AO here, is a mixture of about 13% iso-propanol, about 5% 1-butanol, about 15% ethylene glycol monobutyl ether, about 4% sodium chloride, about 30% water, about 30% cocamidopropyl betaine, and about 2% cocamidopropylamine oxide.

In addition to VES, the fluid of the present application may comprise additives enhancing rheology of the used liquid viscoelastic surfactant system.

The optimal concentration of a given rheology enhancing additive for a given choice of VES surfactant fluid system at a given concentration and temperature, and with given other materials present, can be determined by simple experiments. The total viscoelastic surfactant concentration should be sufficient to form a viscoelastic gel under conditions at which the surfactants have sufficient aggregation tendency. The appropriate amounts of surfactant and rheology enhancer are those necessary to achieve the desired viscosity and shear recovery time as determined by experiment. In general, the amount of surfactant (as active ingredient) may be from about 1 to about 10%. Commercially available surfactant concentrates may contain some materials that we have found may be used as rheology enhancers, for example for concentrate freezing point depression, but normally the amount of such material is not sufficient, when the concentrate is diluted, in the final fluid. The amount of rheology enhancer used, in addition to any that may be already present in the as-received surfactant concentrate, may be from about 0.1 to about 6%, from about 0.25 to about 3.5%, and from about 0.25 to about 1.75%. Mixtures of surfactants and/or mixtures of rheology enhancers may be used.

Another component of the treatment fluid of the present application is a degradable material presented in the form of a degradable fiber or a degradable particle. For example, degradable fibers or particles made of degradable polymers may be used. The degradability of a polymer depends at least in part on its backbone structure. One of the more common structural characteristics is the presence of hydrolysable and/or oxidizable linkages in the backbone. Accordingly, in an embodiment the degradable substance may be a hydrolysable material. Alternatively or additionally, the degradable substance may be an oxidizable material.

The differing molecular structures of the degradable materials that are suitable for the present embodiments give a wide range of possibilities regarding regulating the degradation rate of the degradable material. The rates of degradation of, for example, polyesters, are dependent on the type of repeat unit, composition, sequence, length, molecular geometry, molecular weight, morphology (e.g., crystallinity, size of spherulites, and orientation), hydrophilicity, surface area, and additives. Also, the environment to which the polymer is subjected may affect how the polymer degrades, e.g., temperature, presence of moisture, oxygen, microorganisms, enzymes, pH, and the like. Suitable examples of polymers that may be used as the degradable material in accordance with the embodiments herewith include, but are not limited to, homopolymers, random aliphatic polyester copolymers, block aliphatic polyester copolymers, star aliphatic polyester copolymers, or hyperbranched aliphatic polyester copolymers. Such suitable polymers may be prepared by polycondensation reactions, ring-opening polymerizations, free radical polymerizations, anionic polymerizations, carbocationic polymerizations, coordinative ring-opening polymerization for, such as, lactones, and any other suitable process. Specific examples of suitable polymers include polysaccharides such as dextran or cellulose; chitins; chitosans; proteins; aliphatic polyesters; poly(lactides); poly(glycolides); poly(ε-caprolactones); poly(hydroxy ester ethers); poly(hydroxybutyrates); polyanhydrides; polycarbonates; poly(orthoesters); poly(acetals); poly(acrylates); poly(alkylacrylates); poly(amino acids); poly(ethylene oxide); poly ether esters; polyester amides; polyamides; polyphosphazenes; and copolymers or blends thereof. Other degradable polymers that are subject to hydrolytic degradation also may be suitable.

Poly(lactide) is synthesized either from lactic acid by a condensation reaction or more commonly by ring-opening polymerization of cyclic lactide monomer. The lactide monomer exists generally in three different forms: two stereoisomers L- and D-lactide; and D,L-lactide (meso-lactide). The chirality of the lactide units provides a means to adjust, inter alia, degradation rates, as well as the physical and mechanical properties after the lactide is polymerized. Poly(L-lactide), for instance, is a semicrystalline polymer with a relatively slow hydrolysis rate. This could be desirable in applications where slow degradation of the degradable material is desired. Poly(D,L-lactide) is an amorphous polymer with a much faster hydrolysis rate. This may be suitable for other applications. The stereoisomers of lactic acid may be used individually or combined for use in the compositions and methods of the present embodiments. Additionally, they may be copolymerized with, for example, glycolide or other monomers like ε-caprolactone, 1,5-dioxepan-2-one, trimethylene carbonate, or other suitable monomers to obtain polymers with different properties or degradation times. Additionally, the lactic acid stereoisomers can be modified by blending high and low molecular weight polylactide or by blending polylactide with other aliphatic polyesters. For example, the degradation rate of polylactic acid may be affected by blending, for example, high and low molecular weight polylactides; mixtures of polylactide and lactide monomer; or by blending polylactide with other aliphatic polyesters.

The physical properties of degradable polymers may depend on several factors such as the composition of the repeat units, flexibility of the chain, presence of polar groups, molecular mass, degree of branching, crystallinity, orientation, etc. For example, short chain branches reduce the degree of crystallinity of polymers while long chain branches lower the melt viscosity and impart, inter alia, extensional viscosity with tension-stiffening behavior. The properties of the material utilized can be further tailored by blending, and copolymerizing it with another polymer, or by a change in the macromolecular architecture (e.g., hyper-branched polymers, star-shaped, or dendrimers, etc.). The properties of any such suitable degradable polymers (such as hydrophilicity, rate of biodegration, etc.) can be tailored by introducing functional groups along the polymer chains. One of ordinary skill in the art, with the benefit of this disclosure, will be able to determine the appropriate functional groups to introduce to the polymer chains to achieve the desired effect.

In one embodiment, the method employs degradable fiber when exposed to high pH conditions for a period of time. Examples of such fibers include, but are not limited to polyesters, polyamides, polylactides and the like.

In one embodiment, the method employs polylactic acid, which undergoes a hydrolysis to form a liquid when exposed to a high pH environment as shown in the following reaction scheme:

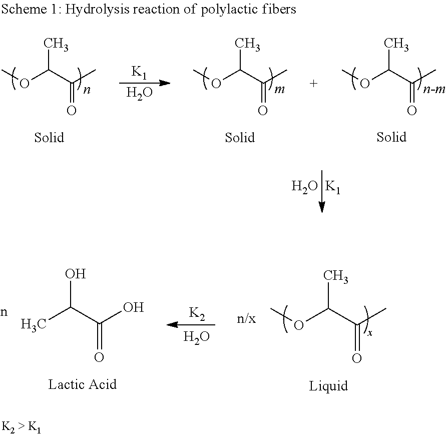

When choosing which composite particles to use in a particular application, there should be taken into account conditions under which a particular application of the present application is implemented. Furthermore, in choosing an appropriate degradable material, one should consider the degradation products that will result. For instance, some may form an acid upon degradation, and the presence of the acid may be undesirable. Others may form degradation products that would be insoluble, and these also may be undesirable. Moreover, these degradation products should not adversely affect other operations or components.

In some embodiments of the present application, the hydrolysable fiber and the used viscoelastic surfactant may form non-solid products upon hydrolysis.

To implement the present application, the additive may be injected into the described therein well-treatment fluid. Said additive comprises at least one component that adjusts a pH value of the fluid (pH control agent), and at least one component that slows down or stops precipitation in the fluid, which has an adverse impact on the process of decomposition of degradable fibers in the fluid during treating the wellbore (precipitation-control agent).

One potential purpose of the agent that adjusts a pH value (pH control agent) may be to provide the hydrolysis of degradable fibers at low temperature, such as, for example, less than 82° C., and 10-50° C.)

Suitable pH control agents will vary with a specific degradable fiber selected to be used, but generally may include those agents which are strongly alkaline materials that may provide and maintain a high pH environment. The pH control agents may provide a pH of 9 or more.

Examples of such strongly alkaline materials include, but are not limited to, metal hydroxides, metal oxides, calcium hydroxide, metal carbonates or bicarbonates, and the like. The alkali and alkaline earth metal may be selected from sodium, magnesium, potassium, and calcium. For example, the strong alkaline substance can be CaO, Ca(OH)₂, MgO, NaOH and KOH.

In some embodiments, the pH control agent may include at least two of these components. The pH control agent may also contain amines base additives such as urea and derivatives thereof, such as dimethylolurea, 1,1-diethylurea, 1,1,3,3-tetramethylurea, 1,3-diethylurea, hydroxyurea, 1,3-diallylurea, ethylurea, 1,1-dimethylurea, as well as nucleophilic amines, such as 4-dimethylaminopyridine (DMAP) and 1,8-diazabicylo[5.4.0]undec-7-ene (DBU). In one embodiment, the pH control agent may also contain a combination of amines with potassium carbonate (K₂CO₃).

Another component of the additive may be an agent that controls precipitation. As stated above, the probable precipitation in the process of degradation of the degradable component in the treatment fluid when using the latter to treat a well, for example, in hydraulic fracturing, has adverse effects, since such precipitate in varying degrees blocks both solid particles of the pH control agents, by preventing them from entering the working fluid at sufficient speed and maintaining the pH at a desirable level, and the degradable fibers themselves, making it difficult for the latter to be decomposed. Accordingly, the task addressed by this agent may be to maximally delay or completely suppress the formation and probable deposition of precipitate during the hydrolysis of degradable components of the treatment fluid, especially at low temperatures (around 50° C.), where the adverse effect of the precipitation may occur particularly strong.

The majority of precipitates may be formed by hardness salts, in particular, calcium salts, such as, for example, calcium sulfate and calcium carbonate. In general, methods of inhibiting and suppressing the precipitation of such salts, in particular with sequestering compounds (sequestering agents), such as chelating compounds may be used herein.

However, the possibility and the efficiency of using certain chelating compounds for the purposes of the present application is not apparent, because they are assumed to be used in the above-mentioned additive in combination with a pH-buffering agent. First of all, since many of the used chelating compounds are acids, their introduction into the additive described above can reduce the pH value of the treatment fluid and, therefore, may slow down the degradation of the degradable particles or fibers. On the other hand, the chelating compounds themselves may also be effective in the environment with a high pH level caused by the pH control agent. Finally, the components of the additive should not interact to each other, starting from the mixing of these components during the preparation of the additives, and till their introduction into the well-treatment fluid.

The present inventors have unexpectedly found that certain chelating acids and salts thereof can serve as suitable precipitation-control agents.

In one embodiment, a precipitation-control agent may be ethylenediaminetetraacetic acid (EDTA):

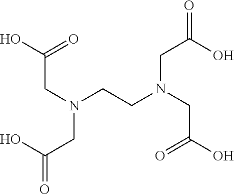 [SMILES: O=C(O)CN(CCN(CC(=O)O)CC(=O)O)CC(=O)O]

and salts thereof. In a specific embodiment, salts of ethylenediaminetetraacetic acid includes mono-, di-, tri- and tetra-sodium salts, and mono-, di-, tri- and tetra-potassium salts.

In another embodiment, the precipitation-control agent may be amino trimethylene phosphonic acid (ATMP)

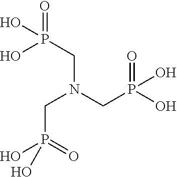 [SMILES: O=P(O)(O)CN(CP(=O)(O)O)CP(=O)(O)O]

and salts thereof. In a specific embodiment, salts of amino trimethylene phosphonic acid include mono-, di-, tri-, tetra-, penta- and hexa-sodium salts, mono-, di-, tri-, tetra-, penta- and hexa-potassium salts.

In order to implement the advantages of the present application most effectively, the weight ratio of the pH-buffering agent and the precipitation-control agent should exceed 1:1 such as, for example, from about 1:1 to about 200:1 or from 2:1 to 50:1.

The additive according to a specific embodiment of the present application may be a solid additive.

In one embodiment of the present application, the solid additive is produced as a granulated additive. To obtain granulated additives, conventional methods used in the field and known in the art can be used. Such methods are described, for example, in WO 2006/030385, which is incorporated b incorporated by reference herein in its entirety.

In another embodiment, the solid additive may be made in the form of an encapsulated additive. The method of encapsulating substances, including solids, wherein the method is suitable for the purposes of the present application, and the device for encapsulation are described in U.S. Pat. No. 4,741,401, which is incorporated b incorporated by reference herein in its entirety. The use of chemical components in the encapsulated form in the oil and gas industry, in particular, in fracturing, is described in U.S. Pat. No. 4,506,734, US 2010/0307744, each of which is incorporated by reference herein in its entirety.

The use of the additives of the present application in the above solid forms has an advantage providing the prolonged in time and controlled output of the components into a solution, consistently with the main process (hydraulic fracturing, blocking of a formation, etc.), for example, by making large granules and reducing thereby the rate of their dissolution as compared with powders. Another advantage may be the convenience of the dosing such additives when introducing thereof into the treatment fluid.

When mixing with the formation-treatment fluid, the additive of the present application may be used in an amount of 0.1-10% or, 0.3-9% (by weight).

The formation-treatment fluid described herein can be applied, in particular, in the treatment of an oil field. As examples, the fluid may be used as a pad fluid and as a carrier fluid in hydraulic fracturing, as a carrier fluid for lost circulation control agents, and as a carrier fluid for gravel packing.

Thus, in one embodiment, the present application provides a method of treating an subterranean formations penetrated by a wellbore, comprising: preparing a treatment fluid comprising a viscosifying polymer or a viscoelastic surfactant having at least one degradable linkage, and a hydrolysable material and also comprising an additive to the formation-treatment fluid of the present application, as described above; and injecting the prepared treatment fluid into a subterranean formation to perform the treatment of the formation.

Adding the additive of the present application to the formation-treatment fluid may be carried out on the surface during injection of the treatment fluid into the treated formation. The additive may then be added to the fluid by an automated feeding system for dry additives, with thorough mixing, within the operational temperature range of the treatment fluid according to standard techniques known to those skilled in the art. Examples of standard devices that can be used in adding and mixing are fracturing blenders (for example, model SBT-625, SBT-615 of Schlumberger, or MT-1060 of National Oilwell Varco).

The formation-treatment fluid used in the method of the present application may comprise various VES or viscosifying polymers, as well as degradable materials from those described herein above.

For example, in one embodiment, the fluid comprises a viscoelastic surfactant, which contains an amide bond. In a specific embodiment, the viscoelastic surfactant has the following formula:

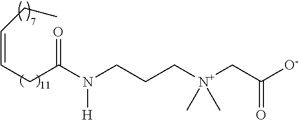

In another possible embodiment, the fluid contains a natural or synthetic viscosifying polymer. In a specific embodiment, such polymer includes a hydratable polysaccharide selected from a galactomannan gum, glucomannan gum and cellulose derivatives. In another embodiment, the liquid contains a natural or synthetic polymer comprising a cellulose derivative selected from guar, hydroxypropyl guar, carboxymethyl guar, carboxymethylhydroxyethyl guar, hydroxyethyl cellulose, carboxymethylhydroxyethyl cellulose, hydroxypropyl cellulose, xanthan.

When using the viscosifying polymer in the fluid, the fluid may further comprise an oxidizing agent. For example, suitable oxidizing agents are ammonium persulfate, potassium bromate, sodium bromate, etc. In some cases, oxidizing agents may also be encapsulated by industrial methods of encapsulation, as described above.

In one embodiment, the hydrolysable material comprised in the fluid may be a hydrolysable fiber. In a specific embodiment, the hydrolysable fibers are selected from the group consisting of polyesters, polyamides and polylactides.

In a specific embodiment, the hydrolysable fiber and the viscoelastic surfactant form non-solid products during hydrolysis.

The ready-to-use formation-treatment fluid, depending on the purpose of treatment, may include various other conventional additives known in the art.

Thus, in some embodiments of the present application, in particular during the fracturing, the fluid further comprises a propping agent or proppant.

In other embodiments, the fluid may comprise an additive selected from the group consisting of corrosion inhibitors, fluid loss additive, and mixtures corrosion inhibitors, fluid loss additive, and mixtures thereof.

In yet another embodiment, the treatment fluid further comprises a foam-forming or fluid-activating gas component, wherein said gas component comprises gas selected from the group consisting of nitrogen, air and carbon dioxide.

The use of the fluid of the present application may provide treatment of a formation in such a way that on the initial stage of the treatment, the used fluid has an increased viscosity, which allows the transfer of large-sized additives, such as proppants. The latter, in combination with the degradable materials available in the fluid provide the compacted structure of the fluid, preventing the fracture from close during the hydraulic fracturing.

After a while, the degradable materials (fibers) are hydrolysed under the action of the component of the additive of the application comprised in the fluid, namely the pH control agent, by inducing the increase in the permeability of the formation and providing an increased flow of produced hydrocarbons therefrom. At the same time, the treatment fluid viscosity decreases, which may be caused by the degradation of the biopolymer molecules or VES molecules, while also increasing the permeability of the formation and providing an increased flow of produced hydrocarbons therefrom.

With that, said process of the fiber hydrolysis occurs with a sufficient speed at relatively low temperatures in the formations, below 82° C., for example, 50° C. and below. This is ensured by the simultaneous action of pH-buffering agents that support the pH value in the treatment fluid at a level sufficient for the reaction with a desired speed, and the precipitation-control agent, which prevents or slows down the possible formation of insoluble precipitate in the system, which inhibits the hydrolysis of degradable materials especially at low temperatures. Thus, a desirable change in the permeability of a proppant pack with a suitable speed is provided, addressing thereby the problem of the present application.

### EXAMPLES

The present embodiments can be further understood from the following examples.

In each of the following examples, the treatment fluid along with degradable fibers was prepared as follows:

A solution of a guar polymer (4.2 kg/m³) was prepared on distilled water. Subsequently, a solution of tetramethylammonium chloride at a concentration of 2 l/m³ and a surfactant in a concentration of 1 l/m³ were added to the prepared solution. The fluid was stirred for a time enough for full hydration of the polymer. After that, encapsulated ammonium persulfate at a concentration of 1.2 kg/m³, polylactic acid fibers (BMD) at a concentration of 4.8 kg/m³, and a granulated additive were added to the fluid at a desirable concentration.

The granulated additive (according to the present invention or comparative) was prepared by mixing components constituting thereof and by placing them into a laboratory granulator. The granulation process was executed until its completion. Then, the fractions with a desirable particle sizes were isolated. Further, the obtained granulated additive was introduced into the treatment fluid in a desirable concentration.

### Example 1

In this example, the hydrolysis of the fibers was tested directly in the treatment fluid.

For these tests, the obtained mixture was placed into a glass bottle. The bottle was placed in water bath heated to a desirable temperature. After a certain time, the sample was removed from the bath and the amount of residual PLA fibers was weighted.

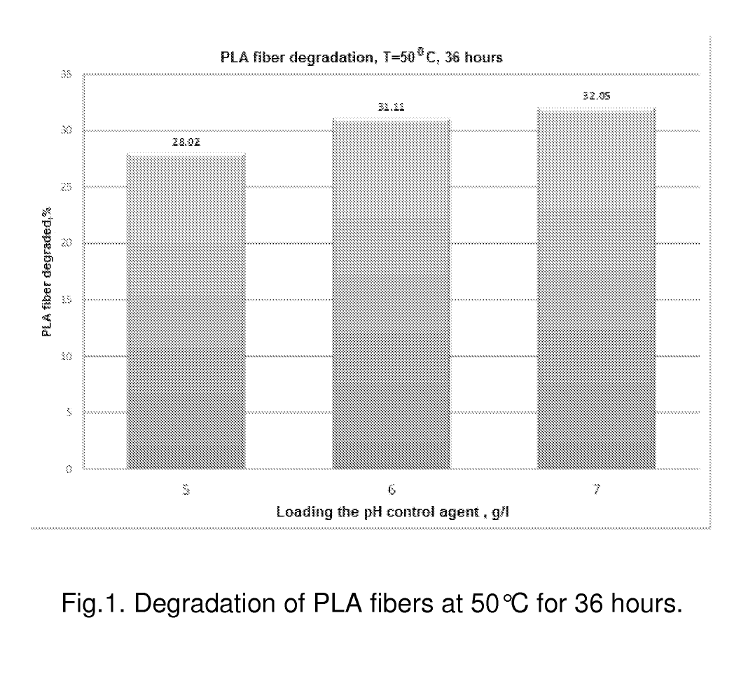

FIG. 1 shows the results of the hydrolysis tests of PLA fibers (4.8 kg/m³) in a polymer solution (hydrated guar solution) with the pH control agent and the precipitation-control agent (added in various concentrations) at temperature of 50° C. Table 1 demonstrates the results of degradation of fibers comprising various concentrations of the additive of the application accelerating the fiber dissolution (based on their components), at 50° C.

TABLE 1

| Concentration of the | Concentration of chemical, | | | Degradation |
|---|---|---|---|---|
| granulated additive, | g/l | | | after 36 |
| g/l | Ca(OH)₂ | NaOH | ATMP | hours, wt. % |
| 7 | 4.8258 | 0.9681 | 1.2061 | 32.05 |
| 6 | 4.1364 | 0.8298 | 1.0338 | 31.11 |
| 5 | 3.447 | 0.6915 | 0.8615 | 28.02 |

As can be seen, higher concentration of CaO and Ca(OH)₂ resulted in faster degradation of PLA fibers. With that, the overall rate of the fiber degradation under condition of the “free” treatment fluid (that is not in a formation and does not comprise large-size additives) is close to the degradation rate disclosed in RU2010138242. Thus, the addition of the precipitation-control agent to the additives of the application does not decrease the efficacy of the fiber degradation.

### Examples 2-5

To assess an effect of the additives of the application on the processes in the treatment fluid under conditions close to real working conditions in a formation at low temperatures, conductivity and permeability were tested in a.

The following examples illustrate the test of the conductivity of proppant 16/20, under an effective pressure applied to the proppant of 2000 psi [13.78 MΠa], and temperature of 50° C., using the same treatment fluid comprising guar gum (4.2 kg/m³) and PLA fibers (4.8 kg/m³).

Conductivity and permeability were measured in a device for determining the proppant pack conductivity (manufactured by ZAO Geologika) according to the following internal procedure.

A mixture of the treatment fluid with the fiber and the additive was prepared according to the above procedure (working fluid). After that, a mixture of the working fluid with proppant was prepared. The resultant mixture was loaded into a cell and the leakage of the working fluid into a formation was simulated, at the same time, the cell was heated to the final temperature (50° C.) and effective pressure (2000 psi) was applied to the proppant.

Pressure differential transducers were zeroed, the thickness of the proppant pack was measured, and the conductivity was determined by pumping 2% solution of potassium chloride at three flow rates. An average conductivity was calculated according to Darcy's law. The test was performed for a required time.

The amount of the used additive (on the basis of one m³ of the treatment fluid) and the amounts of the components constituting thereof are demonstrated in Table 2.

TABLE 2

| | | amount of the additive | | | |
|---|---|---|---|---|---|
| Example | Additive | components, kg | | | |
| No | amount, kg | Ca(OH)₂ | NaOH | ATMP | EDTA |
| 2 | 5.0 | 5.0 | | | |
| 3 | 5.0 | 5.0 | | | |
| 4 | 30.0 | 5.0 | | | 25.0 |
| 5 | 11.2 | 2.6 | 3.0 | 5.6 | |

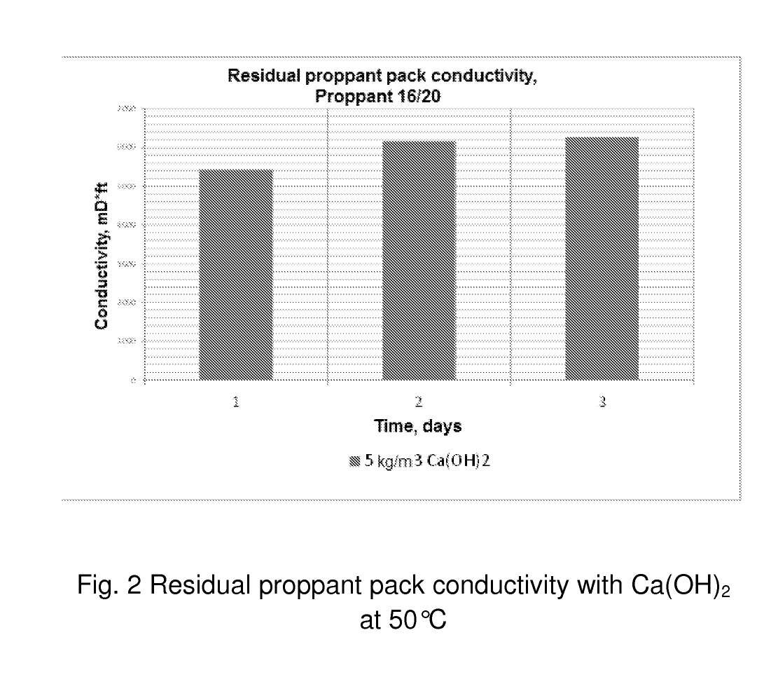

FIG. 2 shows the proppant pack conductivity in Example 2 with addition of Ca(OH)₂ (0.5 kg) and at temperature of 50° C. as a function of time. The initial conductivity values were at a level of 5200 mD*ft; in three days, the conductivity increased to 6200 mD*ft. As can be seen, the proppant pack conductivity increases with time; however, the rate of the conductivity gain is slowed down. This example can be considered as illustration of a nonoptimal set and ratio of components: when the precipitation-control agent is absent the rate of PLA dissolution (and, therefore, the rate of increasing the proppant pack conductivity) becomes too low.

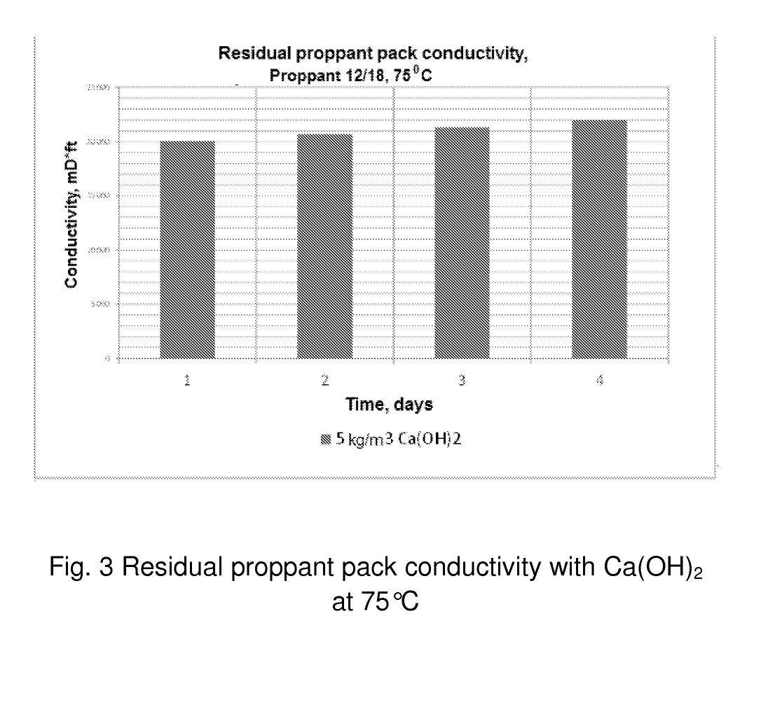

FIG. 3 demonstrates the proppant pack conductivity in Example 3 (proppant size 12/18) when adding Ca(OH)₂ (5.0 kg/m³) and at temperature of 75° C. as a function of time. The initial conductivity values were at a level of 20000 mD*ft; in four days, the conductivity increased to 24000 mD*ft. The observed conductivity values are associated with an increased rate of PLA hydrolysis with increasing temperature. Herein, the increase in the proppant pack conductivity with time also is observed.

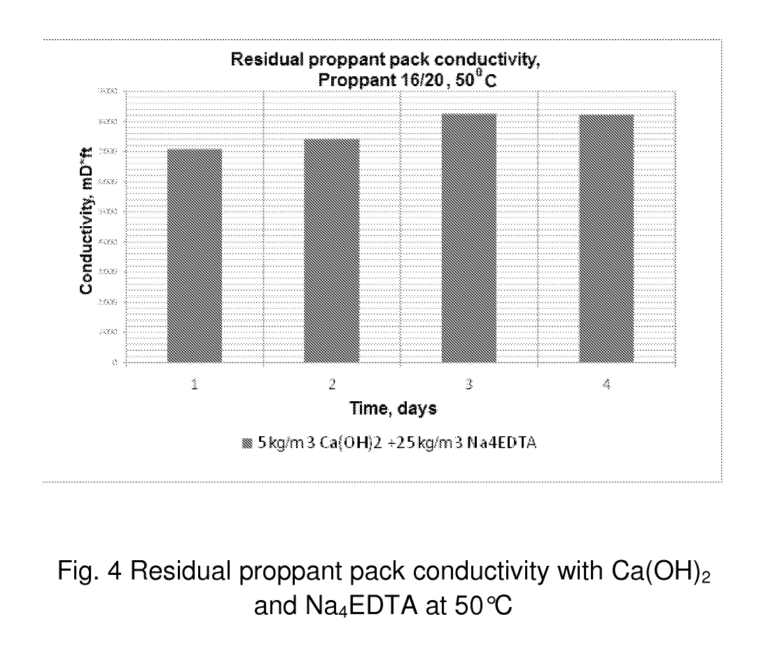

FIG. 4 demonstrates the proppant pack conductivity in Example 4 when adding Ca(OH)₂ (0.5 kg) and EDTA tetra-sodium salt (25 kg/m³_) at temperature of 50° C. The initial conductivity values were at a level of 7089 mD*ft; in four days the conductivity increased to 8215 mD*ft. This example demonstrates effects of the nonoptimal ratio between the pH control agent and the precipitation-control agent. On the one hand, the presence of the precipitation-control agent provides increasing the initial conductivity; on the other hand, in spite of the observed increasing the proppant pack conductivity with time, the rate of this increase is not optimal.

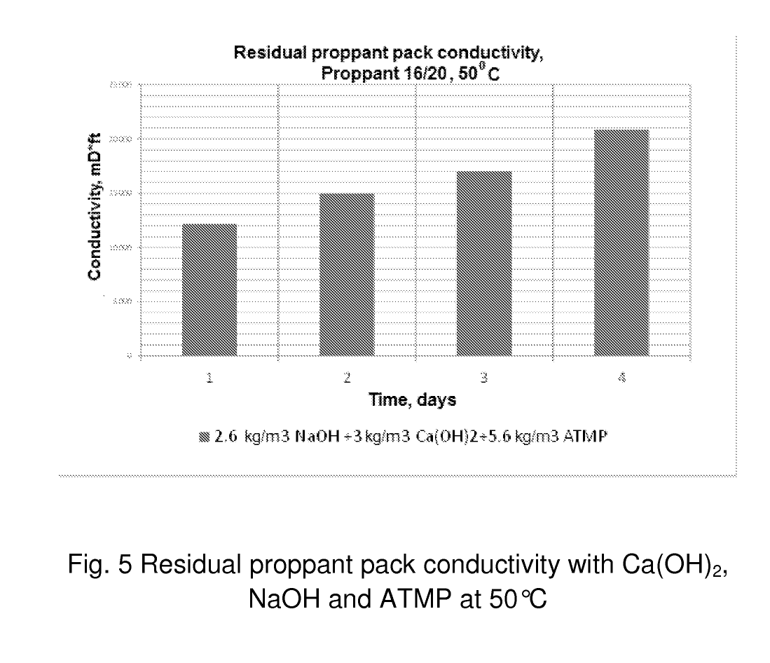

FIG. 5 demonstrates the proppant pack conductivity in Example 5 when adding Ca(OH)₂ (2.6 kg/m³), NaOH (3 kg/m³) and ATMP (5.6 kg/m³) at temperature of 50° C. The initial conductivity values were at a level of 12117 mD*ft; in four days the conductivity increased to 20833 mD*ft. The increase in the proppant pack conductivity and the increase in the rate of the conductivity gain are observed due to using the ratio of the components, which is close to optimal.

The foregoing disclosure and description of the application are illustrative and explanatory thereof and it can be readily appreciated by those skilled in the art that various changes in the size, shape and materials, as well as in the details of the illustrated construction or combinations of the elements described herein can be made without departing from the spirit of the application.

1. An additive to a formation-treatment fluid comprising:
a pH adjusting agent; and
a precipitation-control agent.

2. The additive of claim 1, characterised in that the pH adjusting agent comprises at least one component selected from the group including: hydroxides, oxides, carbonates and bicarbonates of alkali and alkaline earth metals.

3. The additive of claim 2, characterised in that the alkali and alkaline earth metals are selected from sodium, magnesium, potassium, and calcium.

4. The additive of claim 3, characterised in that the pH adjusting agent comprises at least two of said components.

5. The additive of claim 1, characterised in that the pH adjusting agent provides a pH value in the formation-treatment fluid no less than 9.

6. The additive of claim 1, characterised in that the precipitation-control agent comprises at least one component selected from the group including: ethylenediaminetetraacetic acid (EDTA) and salts thereof, and amino trimethylene phosphonicacid (ATMP) and salts thereof.

7. The additive of claim 6, characterised in that the salts of ethylenediaminetetraacetic acid includes mono-, di-, tri- and tetra-sodium salts, and mono-, di-, tri- and tetra-potassium salts.

8. The additive of claim 7, characterised in that the salts of amino trimethylene phosphonic acid include mono-, di-, tri-, tetra-, penta- and hexa-sodium salts, and mono-, di-, tri-, tetra-, penta- and hexa-potassium salts.

9. The additive of claim 1, characterised in that a weight ratio between the pH adjusting agent and the precipitation-control agent is in the range of from about 1:1 to about 200:1.

10. The additive of claim 1, characterised in that the additive is a solid additive.

11. The additive of claim 10, characterised in that the additive is granulated.

12. The additive of claim 1 or claim 11, characterised in that the additive is encapsulated.

13. The additive of claim 12, characterised in that the encapsulated material is selected from a group of synthetic polymers.

14. A method of treating a subterranean formations penetrated by a wellbore, comprising:
preparing a treatment fluid comprising:
a viscosifying polymer having at least one degradable linkage or a viscosifying polymer,
a hydrolysable material,
an additive to the formation-treatment fluid according to any of claims 1-13;
and
injecting the prepared treatment fluid into the subterranean formation.

15. The method of claim 14, characterised in that the hydrolysable material is a hydrolysable fiber.

16. The method of claim 15, characterised in that the fiber is selected from the group including: polyesters, polyamides and polylactides.

17. The method of claim 16, characterised in that the hydrolysable fiber and a viscoelastic surfactant form non-solid products during hydrolysis.

18. The method of claim 14, characterised in that the viscoelastic surfactant comprises an amide bond.

19. The method of claim 18, characterised in that the viscoelastic surfactant has the following formula:

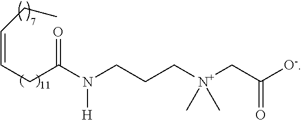

20. The method of claim 14, characterised in that the viscosifying polymer comprises a natural or synthetic polymer.

21. The method of claim 14, characterised in that when using the viscosifying polymer in the fluid, the fluid may further comprise an oxidizing agent.

22. The method of claim 14, characterised in that the natural or synthetic polymer includes a hydratable polysaccharide selected from a galactomannan gum, glucomannan gum and cellulose derivatives.

23. The method of claim 22, characterised in that the natural or synthetic polymer is a cellulose derivative selected from guar, hydroxypropyl guar, carboxymethyl guar, carboxymethylhydroxyethyl guar, hydroxyethyl cellulose, carboxymethylhydroxyethyl cellulose, hydroxypropyl cellulose, and xanthan.

24. The method of claim 14, characterised in that the fluid further comprises a propping agent.

25. The method of claim 14, characterised in that the fluid comprises the additive selected from the group including corrosion inhibitors, fluid loss additive, and a mixture thereof.

26. The method of claim 14, characterised in that the fluid further comprises a foam-forming or fluid-activating gas component, wherein said gas component comprises the gas selected from the group including nitrogen, air and carbon dioxide.
